(19) United States
(12) Patent Application Publication
(10) Pub. No.: US 2007/0252849 A1
(43) Pub. Date: Nov. 1, 2007

(54) Device and method modifying image of color display

(75) Inventor: Hung-Chen Wang, Hsinchu (TW)

Correspondence Address: BIRCH STEWART KOLASCH & BIRCH, PO BOX 747, FALLS CHURCH, VA, 22040-0747, US

(73) Assignee: Microtek International Inc.

(21) Appl. No.: 11/413,142

(22) Filed: Apr. 28, 2006

(51) Int. Cl. G09G 5/02

(52) U.S. Cl. 345/602

(57) ABSTRACT

A color transformer of a colorful display includes storage, a data controller and a data processor. The data controller builds a multi-dimensional color lookup table and saves the multi-dimensional color lookup table to the storage to access it freely. The data processor sends color data to the data controller to lookup the correspondent color in the multi-dimensional color lookup table to obtain the output color. By looking up the multi-dimensional color lookup table, the color transformer transfer each input color to an output color independently.

### 1. FIELD OF THE INVENTION

This present invention relates to a color-modifying device applied to a color display, more especially, to a color-modifying device using a multi-dimensional color-mapping lookup table to transform an input image to an output image in the display.

### 2. BACKGROUND OF THE RELATED ART

A color modifier, applied in a color display, mixes three fundamental colors red, green and blue (denoted RGB) to enrich the image, that is, mixing RGB in a different ratio or different grayscale in a thin film transistor liquid crystal display (denoted TFT-LCD) obtains a various color.

In prior art, the color modifier maps a color to another color by a palette, and the palette is divided into 3 sub-palettes corresponding to 3 fundamental colors respectively. When a mapping maps a fundamental color with an origin grayscale to the fundamental color with another grayscale in the palette, the origin color maps to a new color, that is, the modification is dependent.

FIG. 1 is a schematic draw to show the content of a palette 10 in a prior art. There exists three sub-map representing (Rk, Rv), (Gk,Gv) and (Bk, Bv) for 3 fundamental color respectively. In generally, a display denoting 256×256×256 means there are three fundamental colors and each fundamental color has 256 grayscales.

A mapping of the palette maps a color denoted (Rx, Gx, Bx) to another color denoted (Ry, Gy, By), and the colors (Rx, Gl, Bk) with different Gl and Bk map to (Ry, Gl, Bk), in the same reason, (Rl, Gx, Bl) to (Rl, Gy, Bk) and (Rl, Gk, Bx) to (Rl, Gk, By), that is to say a mapping affects 3×256×256 colors.

### SUMMARY OF THE INVENTION

The objective of this present invention is to provide a device with an independent mapping for each color.

Another objective of this present invention is to introduce the method using the device to modify a color to a new color.

The invention discloses a color transformer applied to a colorful display to modify the color of an image to achieve the aforesaid objectives, and the color transformer includes a memory, a data controller, connected to the memory, building the color-mapping lookup table, saving the color-mapping lookup table in the memory and transforming an input image data to an output image data according to the color-mapping lookup table and an image processor, connected to the data controller, receiving the input image data and exporting the output image data, wherein the color-mapping lookup table is a multi-dimensional color lookup table.

The invention discloses another color transformer applied to a colorful display to modify the color of an image to achieve the aforesaid objectives, and the color transformer comprises a memory, a data controller, connected to the memory, building a color-mapping lookup table, saving the color-mapping lookup table in the memory, transforming an input image data to an output image data and exporting the output image data and an image processor, connected to the data controller, receiving the input image data and delivering the input image data to the data controller, wherein the color-mapping lookup table is a multi-dimensional color lookup table.

This present invention discloses a method using the above color transformers to achieve the aforementioned objectives, which method includes building a color-mapping lookup table by a data controller, wherein the color-mapping lookup table includes many index keys and index values and each index key is correspondent to an index value, saving the color-mapping lookup table to a memory and reading the color-mapping lookup table from the memory by the data controller flexibly, transforming an input image data to an output image data by the data controller, wherein the input image data acts as the index key to lookup the correspondent index value to be the output image data and exporting the output image data.

### BRIEF DESCRIPTION OF THE DRAWINGS

FIG. 1 shows a schematic mapping of a palette in a prior art.

FIG. 2 shows a schematic view of a color transformer in an embodiment of this present invention.

FIG. 3 shows a schematic view of a color transformer in another embodiment of this present invention.

FIG. 4 shows a flow chart of transforming a color to another color in an embodiment of this present invention.

FIG. 5 shows a schematic mapping of color lookup table in an embodiment of this present invention.

### DETAILED DESCRIPTION OF THE INVENTION

A 3-dimensional color coordinate system with 3 axes representing 3 fundamental colors red, green and blue respectively describes a color by a coordinate (R, G, B). In generally, a fundamental color has 256 grayscales in a TFT-LCD, that is to say all colors in a color TFT-LCD may be descript by 256×256×256 discrete points in the color coordinate system.

A transformation of color means a color maps to another color, that is, a point maps to another point in 3-dimensional color coordinate system, and the origin color points construct a variable region (or called a Domain) and the mapping color points do a value region (or called a Range). The point called an index key in Domain and an index value in Range, and the index key and value constructs a mapping, and all mapping construct a color lookup table.

FIG. 2 shows a schematic view of an embodiment to realize the color transformer of this present invention. A memory 112 is connected to a data controller 111, and the controller 111 builds a 3-dimensional color lookup table (denoted LUT) and saves the LUT in the memory 112 for accessing the LUT flexibly. An image processor 120 connected to the data controller 111 receives the input image data, delivers the input image data to the data controller 111 to transform to an output image data and exports the output image data to a panel 130 connected to the image processor 120.

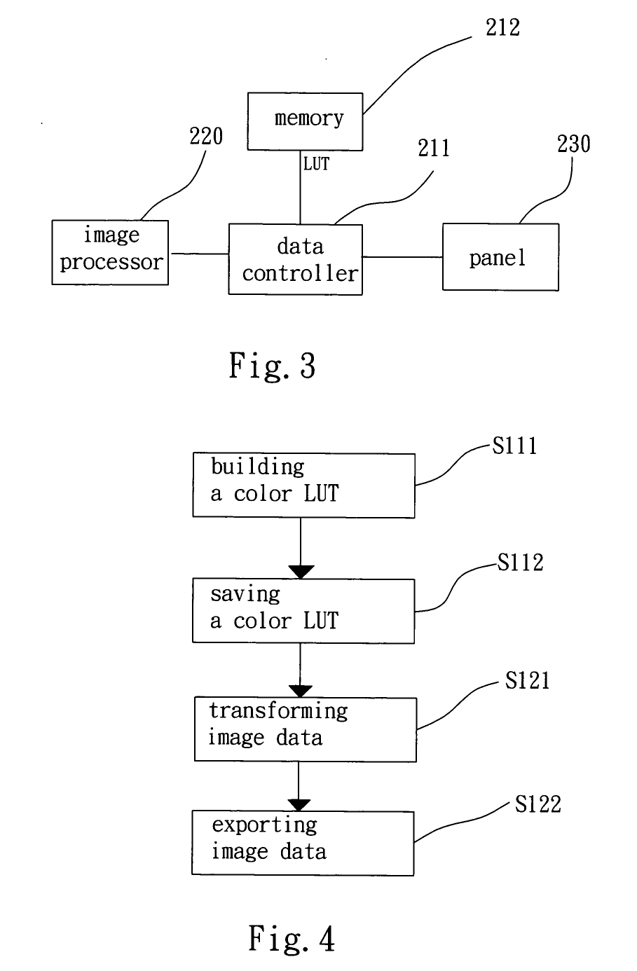

FIG. 3 shows a schematic view of another embodiment to realize the color transformer of this present invention. This embodiment is similar to the aforementioned one, except that the data controller 211 exports the output image data to the panel 230 connected the data controller 211.

A memory 212 is connected to a data controller 211, which builds a 3-dimensional LUT, saves the LUT in the memory 212, transforms an input image data to an output image data and exports the output image data to a panel 230 connected to the data controller 211. An image processor 220 connected to the data controller 211 receives the image data and delivers the input image data to the data controller 211.

FIG. 4 shows the flow chart of the method modifying the color in a color transformer of the embodiment aforementioned in FIG. 2 (FIG. 3).

Step S111 is to build a 3-dimensional color lookup table (LUT) means the data controller 111 in FIG. 2 (211 in FIG. 3) builds a 3-dimensional color LUT.

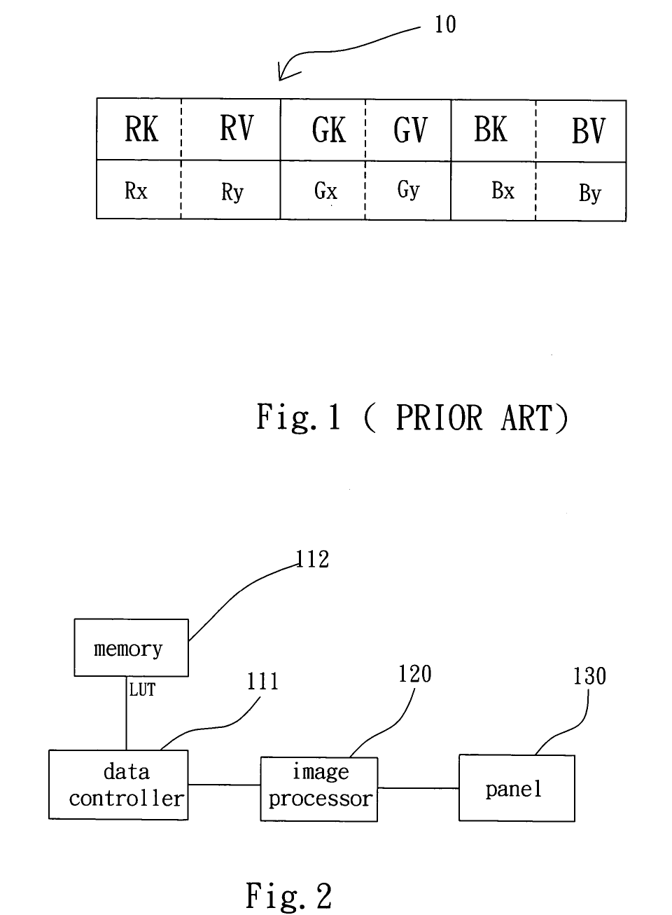

Step S112 is to save the 3-dimensional color LUT means the data controller 111 in FIG. 2 (211 in FIG. 3) saves the 3-dimensional color LUT in the memory 112 in FIG. 1 (212 in FIG. 3) for accessing flexibly.

Step S121 is to transform an input image data to an output image data means the image processor 120 in FIG. 2 (220 in FIG. 3) receives the input image data and delivers the input image data to the data controller 111 in FIG. 2 (211 in FIG. 3).

Step S122 is to export the output image data means the data controller 111 in FIG. 2 receives the output image data and delivers the output image data to the image processor 120 in FIG. 2, and finally the image processor 120 in FIG. 2 exports to the panel 130 in FIG. 2, or the data controller 211 in FIG. 3 exports the output image data to the panel 230 in FIG. 3 directly.

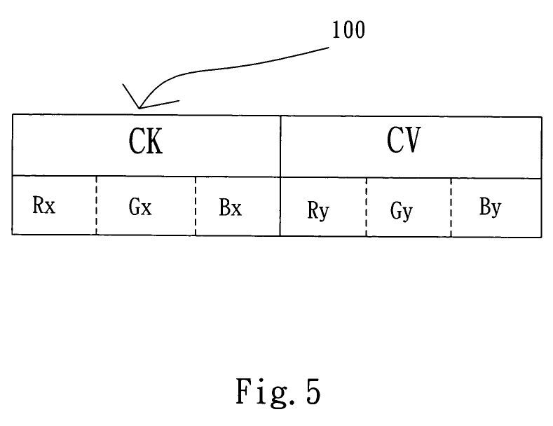

FIG. 5 shows a schematic mapping of color lookup table in an embodiment of this present invention. The (Ck, Cv) means (index key, index value) of a 3-dimensional color LUT, and each Ck represents (Rx, Gx,Bx) and Cv does (Ry, Gy, By). Domain has 256×256×256 points and Range does 256×256×256 points also, and each (Ck, Cv) describes an independent mapping. Each mapping is independent to another mapping, that is, the mapping is one by one to improve the dependent mapping in the prior art, which Domain 256×256×256 maps to Range 3×256×256.

For convenience, a fundamental color has 256 grayscales and the display uses 3 fundamental colors to represent the color, but this invention should apply to more grayscales of a fundamental color and more fundamental colors, so more grayscales and more fundamental colors should included in this invention.

Although the present invention has been explained in relation to its preferred embodiment, it is to be understood that other modifications and variation can be made without departing the spirit and scope of the invention as claimed.

What is claimed is:

1. A color transformer, applied to a colorful display to modify the color, comprising:
a memory;
a data controller, connected to the memory, building a color-mapping lookup table, saving the color-mapping lookup table in the memory and transforming an input image data to an output image data according to the color-mapping lookup table; and
an image processor, connected to the data controller, receiving the input image data and exporting the output image data,
wherein the color-mapping lookup table is a multi-dimensional color lookup table.

2. A color transformer according to claim 1, wherein a panel is connected to the image processor to show output image data.

3. A color transformer according to claim 2, wherein the panel is a monitor, a television or a high-density television.

4. A color transformer, applied to a colorful display to modify the color, comprising:
a memory;
a data controller, connected to the memory, building a color-mapping lookup table, saving the color-mapping lookup table in the memory, transforming an input image data to an output image data and exporting the output image data; and
an image processor, connected to the data controller, receiving the input image data and delivering the input image data to the data controller,
wherein the color-mapping lookup table is a multi-dimensional color lookup table.

5. A color transformer according to claim 4, wherein a panel is connected to the data controller to show output image data.

6. A color transformer according to claim 4, wherein the panel is a monitor, a television or a high-density television.

7. A method modifying a colorful display, using a color transformer, comprising:
building a color-mapping lookup table by a data controller, wherein the color-mapping lookup table includes many index keys and index values and each index key is correspondent to an index value;
saving the color-mapping lookup table to a memory and reading the color-mapping lookup table from the memory by the data controller flexibly;
transforming an input image data to an output image data by the data controller, wherein the input image data acts as the index key to lookup the correspondent index value to be the output image data; and
exporting the output image data.

8. A method modifying a colorful display according to claim 7, wherein exporting the output image data means data controller or an image processor exports the output image data.
